(19) United States
(12) Patent Application Publication
(10) Pub. No.: US 2017/0017916 A1
(43) Pub. Date: Jan. 19, 2017

(54) Service Provider Qualification

(71) Applicant: TaskEasy, Inc., Walnut, CA (US)

(72) Inventors: Ken R. Davis, Salt Lake City, UT (US); Fraser M. Smith, Salt Lake City, UT (US)

(21) Appl. No.: 15/196,610

(22) Filed: Jun. 29, 2016

Related U.S. Application Data
(60) Provisional application No. 62/191,967, filed on Jul. 13, 2015.

(51) Int. Cl. G06Q 10/06; G06Q 40/08; G06Q 10/10; G06Q 20/10; H04L 29/08; H04W 4/00

(52) U.S. Cl. CPC G06Q 10/063112; H04L 67/02; H04L 67/20; H04W 4/001; G06Q 10/1093; G06Q 20/102; G06Q 40/08

(57) ABSTRACT

Technology is described for qualifying a service provider. The method may include inviting the service provider to join a task allocation application that is executing using a processor. An online reference may be received from the service provider to verify a service provider's identity via an online presence. A desired territory may be received from the service provider. The territory provided by the service provider may be tested to determine whether a task is available in the territory using the processor. Schedule availability for the service provider to perform a task in the territory may be verified. The service provider may be qualified to join the task allocation application based on verifying the online references, desired territory, and schedule availability of the service provider.

### PRIORITY DATA

This application claims the benefit of U.S. Provisional Patent Application Ser. No. 62/191,967, filed on Jul. 13, 2015, which is incorporated herein by reference.

### BACKGROUND

Many goods can be purchased in a commoditized way. A consumer can have certain criteria when deciding to purchase goods, and where the goods meet the desired criteria, then the consumer generally does not generally care about who provides the goods.

Services have typically been less commoditized. Rather, services are often purchased after comparing service providers to one another. For example, service providers can be compared through a bidding process, interviews, and/or online reviews. Even such service provider comparisons can be challenging for a consumer to interpret due the non-uniformity in services supplied by various service providers. This may result in uncertainty to the consumer as to the comparative cost of services, reliability of services, and the quality of services provided by various service providers.

### BRIEF DESCRIPTION OF THE DRAWINGS

FIG. 1 is a block diagram illustrating an example of a system to qualify a service provider to receive a task from a task allocation provider and/or application.

FIG. 2 is a diagram illustrating examples of information collected or used to qualify a service provider.

FIG. 3 is a flowchart illustrating an example method for qualifying a service provider.

FIG. 4 is a flowchart illustrating another example method for qualifying a service provider.

FIG. 5 is a block diagram illustrating an example of a computing device that may be used in qualifying service providers.

### DETAILED DESCRIPTION

Reference will now be made to the examples illustrated in the drawings, and specific language will be used herein to describe the same. It will nevertheless be understood that no limitation of the scope of the technology is thereby intended. Alterations and further modifications of the features illustrated herein, and additional applications of the examples as illustrated herein, which would occur to one skilled in the relevant art and having possession of this disclosure are to be considered within the scope of the description.

A technology is described for qualifying a service provider to perform services for a customer via a networked computer system. The service provider may be qualified to ensure that the service provider has the requisite knowledge, skills, experience, location, etc. to perform tasks (e.g., lawn mowing, snow removal, house painting) for customers. For example, the service provider may be qualified to perform the tasks based on information furnished by the service provider (e.g., qualifications, work history). The service provider may furnish the information after receiving an invitation to join a task allocation application. Upon verifying the information provided by the service provider, the service provider may be authorized to receive tasks from the task allocation provider or task allocation application.

The information used to qualify the service provider may include online references, referral information, service history, qualifications, credit and criminal history, bank account information, schedule availability, training completion, desired territory information, insurance information, tax information, ownership of a mobile device, and other qualifying information. The service provider may provide information before the task allocation application may be enabled to assign the task to the service provider. The information provided by the service provider may also be used to lookup information about the service provider from other data stores, services or information sites that can be referenced through a computer network (e.g., the internet). For example, the identity of the service provider may be used to perform a criminal history check using a third-party data store or service. Additional task related information may be requested from the service provider, such as information regarding the type of tools (e.g., lawn mower, cleaning tools) used by the service provider or employees that may be employed at the job site.

In one example, each piece of information provided by the service provider may be verified before the task allocation application is allowed to assign a task to the service provider. Alternatively, the service provider may be temporarily assigned the task before each piece of information has been verified, for example, because of a delay in verifying the piece of information (e.g., on a weekend or a holiday). However, the task allocation application may stop assigning tasks to the service provider when a piece of information cannot be verified or is discovered to be inaccurate or fabricated or previously assigned tasks may be revoked.

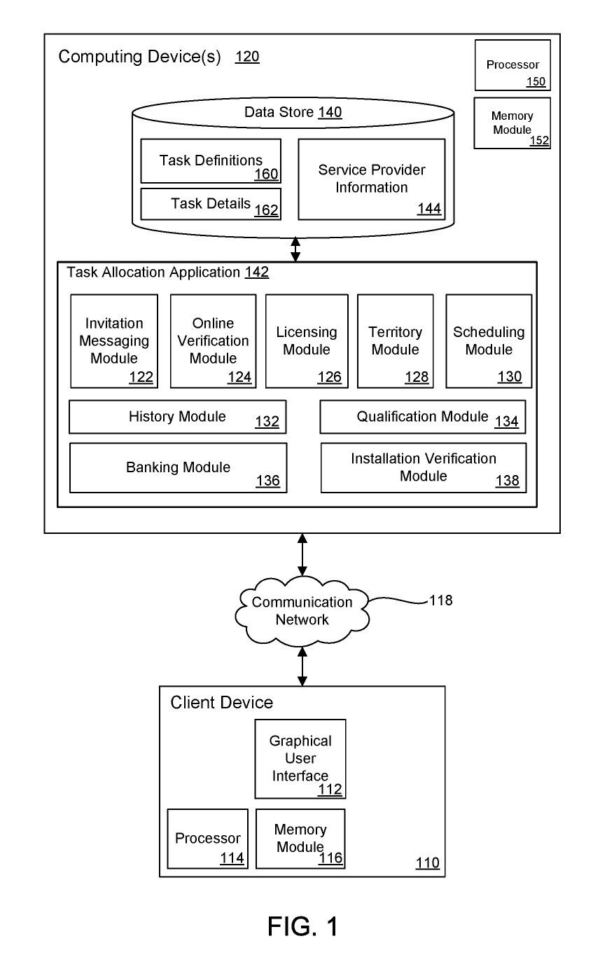

As illustrated in FIG. 1, a system can be used for qualifying a service provider to receive a task from the task allocation application 142 and related system. The system may communicate with a client device 110 through which the service provider provides qualification information (e.g., bank account information, tax information, identity information, referral information, etc.) to a computing device 120 in the system before receiving a task over a communication network 118. The communication network can be a local area network (LAN), wide area network (WAN), the internet, or another computing network.

The qualification information for the service provider may be entered into a graphical user interface 112 on the client device 110. For example, the service provider may enter business license information, service history, and other qualifying information into the graphical user interface 112 of the client device 110. The client device may include a processor 114 and a memory module 116. A client device 110 may be a device such as, for example, a desktop computer, a laptop, a tablet, a mobile device, a television, a cell phone, a smart phone, a hand held messaging device, a set-top box, a gaming console, a personal data assistant, an electronic book reader, heads up display (HUD) glasses, or any device with a display that may present the graphical user interface 112 for entering and receiving qualification information from the service provider.

The computing device 120 may comprise, for example, a server computer or any other system providing computing capability. Alternatively, a plurality of computing devices 120 may be employed that are arranged, for example, in one or more server banks, computer banks or other computing arrangements. For example, a plurality of computing devices 120 together may comprise a clustered computing resource, virtualization server, a grid computing resource, and/or any other distributed computing arrangement. Such computing devices 120 may be located in a single installation or may be distributed among many different geographical locations. The computing device 120 may include a processor 150 and a memory module 152. For purposes of convenience, the computing device 120 is referred to herein in the singular. Even though the computing device 120 is referred to in the singular, it is understood that a plurality of computing devices 120 may be employed in the various arrangements as described above.

Various applications and/or other functionality may be executed in the computing device 120 according to various embodiments. Also, various data may be stored in a data store 140 that is accessible to the computing device 120. The term “data store” may refer to any device or combination of devices capable of storing, accessing, organizing, and/or retrieving data, which may include any combination and number of data servers, relational databases, object oriented databases, simple web storage systems, cloud storage systems, data storage devices, data warehouses, flat files, and data storage configuration in any centralized, distributed, or clustered environment. The storage system components of the data store may include storage systems such as a SAN (Storage Area Network), cloud storage network, volatile or non-volatile RAM, optical media, or hard-drive type media. The data stored in the data store 140, for example, may be associated with the operation of the various applications and/or functional entities described below.

The data stored in the data store 140 may include task definitions 160 and task details 162. The task definitions 160 and task details 162 may be accessed by a task allocation application 142 in order to enable the assignment of tasks (e.g., lawn mowing, house cleaning, snow plowing) to service providers. The task allocation application 142 may determine whether a service provider is qualified (or temporarily qualified) to be assigned a task. The task allocation application 142 may assign the task to the service provider, based on the territory defined for the service provider and the service provider's schedule availability. The service provider may submit a desired territory but a defined territory may be set for the service provider based on available territories, the service provider's home location, number of services providers in a territory and surrounding territories, and other territory related variables. In addition, the task allocation application 142 may assign tasks based on the service provider's skills and qualifications. In some situations, when being notified that a service provider has been disqualified from performing tasks by the computing device 120, the task allocation application 142 may stop assigning tasks to the service provider.

The data stored in the data store 140 may include service provider information 144. The service provider information 144 may include information about a plurality of service providers. The service provider information 144 may be provided by the service provider when the service provider is being qualified to perform tasks by the computing device 120. The service provider information 144 may include, but is not limited to, a home location, service provider organization information (i.e., corporation info, etc.), online reference information, referral information, service history, a list of qualifications, credit and criminal history, bank account information, schedule availability, training completion, desired territory information, insurance information, tax information, ownership of a mobile device, tool information, employees and other service provider related information. The computing device 120 may use the service provider information 144 in determining whether a service provider is qualified or unqualified to perform tasks. The service provider information 144 associated with a service provider may be modified when the service provider updates or adds additional information or deleted when the service provider deactivates a user account associated with the task allocation application 142.

Components that may be executed on the computing device 120 may include an invitation messaging module 122, an online verification module 124, a licensing module 126, a territory module 128, a scheduling module 130, a history module 132, a qualification module 134, a banking module 136, an installation verification module 138, and other applications, services, processes, systems, engines, or functionality not discussed in detail in this description.

The invitation messaging module 122 may be configured to invite the service provider to join the task allocation application 142. The service provider may be invited to join the task allocation application 142 through an existing service provider, a customer, or marketing efforts. The invitation messaging module 122 may send an invitation after the service provider initiates a qualification process for becoming a qualified service provider. The service provider may then register or sign up with a website to begin the pre-qualification process. Alternatively, the pre-qualification process may be performed in-person with the service provider and submitted through the client device on behalf of the service provider. The service provider may provide basic information, such as name, email address, physical address, years of experience, etc. to register with the task allocation application 142 and begin the pre-qualification process. Based on this information provided during the pre-qualification process, the invitation messaging module 122 may send the invitation to the service provider to become qualified to receive tasks from the task allocation application 142. A “qualified service provider” may be defined as a service provider that has become fully qualified or certified to receive tasks from the task allocation application 142.

In one example, the invitation messaging module 122 may send the invitation to the service provider after a representative associated with the task allocation application 142 has completed a verbal and in-person conversation with the service provider. In another example, the service provider may be invited via email or other electronic messaging to become qualified to perform tasks for customers (i.e., to become a qualified service provider). More specifically, the invitation messaging module 122 may send an electronic invitation to a service provider if a customer or a qualified service provider recommends that service provider. Further, the invitation messaging module 122 may send the invitation to a selected service provider (e.g., service providers included in an online database) as a form of targeted marketing.

The online verification module 124 may be configured to verify a service provider's online presence. In particular, the online verification module 124 may receive an online reference from the service provider to verify a service provider's identity via an online presence. The online verification module 124 may verify the online reference using social media applications, social network relationships, electronic communication applications, media network links, website presence, credit databases and online databases. Accordingly, the service provider may provide information that can be verified to show that the service provider is a real person capable of performing services. For example, the service provider may provide a website address that describes the services offered (e.g., lawn mowing) and information about the service provider (e.g., contact information, experience, hours of availability), and the website can be confirmed to have existed for a number of years. The service provider may provide classified ads or other advertisement materials indicating that the service provider has actively advertised to potential customers. The service provider may also provide customer reviews for services that have been performed in the past. For example, the online verification module 124 may determine the existence of and the experience of the service provider from the online references. This may include identifying whether the service provider may work for a company or is a sole proprietor, and identifying the quality of the services performed by the service provider. As another example, the software may determine whether the service provider has a minimum number of links (e.g., more than one hundred) in a social networking application such as Facebook, LinkedIn or another social network to determine that the entity is a real service provider.

The licensing module 126 may be configured to verify the service provider's licenses, permits, certifications or qualifications. For example, the service provider may indicate that he or she is a licensed house painter or electrician. The license may have been issued after the service provider passed an examination and paid a licensing fee. The licensing module 126 may verify that the license is valid, current (i.e., not expired), and has not been suspended within a certain period of time. In one example, the licensing module 126 may electronically verify the license with an organization that issued the license. The licensing module 126 may perform similar actions when verifying permits and certifications provided by the service provider.

The territory module 128 may be configured to determine whether a task is available in a territory desired by the service provider. The service provider may indicate a geographical area (e.g., a city, a neighborhood, a county) in which the service provider can perform services for customers, and the service provider may indicate that tasks outside the geographical area may be considered on a case-by-case basis. In addition, the service provider may indicate that tasks outside the geographical area, but within a certain distance (e.g., two miles from a base location), can be performed. Alternatively, the service provider may explicitly indicate that tasks cannot be performed outside the geographical area. The territory module 128 may determine whether the task is within the geographical area indicated by the service provider. If the task is outside the geographical area, the territory module 128 may determine whether the task can be performed by the service provider based on exceptions (e.g., within a certain distance outside the geographical area) provided by the service provider.

The territory module 128 may also assign a territory to the service provider around or near the location of the service provider's home location. The service provider may outline a desired territory but some or all of that territory may not be available due to an existing allocation of service providers and customers. Thus, an appropriate territory may be assigned by the territory module 128.

The scheduling module 130 may be configured to verify schedule availability for the service provider to perform a task in the territory. The service provider may provide an availability schedule that indicates the days and times when the service provider can be assigned a task. The availability schedule may be modified by the service provider when the service provider's schedule changes (e.g., a new task is scheduled, a task is cancelled, etc.). The scheduling module 130 may access the current availability schedule for the service provider to verify that the service provider can perform the assigned task in the territory. After the task is assigned to the service provider, the scheduling module 130 may update the availability schedule to reflect the newly assigned task. In addition, the scheduling module 130 may send an updated availability schedule to the service provider and provide a reminder notification before the task is to be performed.

The history module 132 may be used to verify a service provider's references or service history. The service provider may provide references of current or past supervisors, teachers, colleagues, employees, customers, friends, family members, etc. The service provider may indicate that the references can attest to the service provider's skill level, qualifications, dependency, etc. The service provider may provide the name and contact information (e.g., phone number, email address) for each reference. The history module 132 may communicate with each reference (e.g., via email, texting, social networking, or other websites) to verify statements provided by the service provider. Alternatively, a human agent may retrieve history information from the history module 132 and verify the history information via phone. In addition, the service provider may provide a service history of previous tasks that were performed for customers. For example, the service history may indicate the types of tasks performed by the service provider (e.g., lawn mowing), a task quantity per a given time period (e.g., ten lawn mows a month), the period of time for which certain tasks have been performed (e.g. three years of lawn mowing experience), and the customers for which the services were performed. The history module 132 may randomly choose customers to communicate with, via email or telephone, to verify the accuracy of the statements contained in the service history.

The qualification module 134 may qualify the service provider when qualification criteria are met. For example, the qualification module 134 may receive a notification from the online verification module 124, the licensing module 126, the territory module 128, the scheduling module 130, and the history module 132 that the qualification criteria, for each respective module, has been satisfied (i.e., provided by the service provider and verified to be accurate). After receiving the notifications from the other modules, the qualification module 134 may qualify the service provider to perform tasks assigned by the task allocation application 142. In one example, the qualification module 134 may temporarily qualify a service provider, even though the qualification criteria have not been met. This means the qualification module 134 may temporarily qualify the service provider when waiting to receive notifications from some of the other modules. When a notification is received from a module that qualification criterion for a temporarily qualified service provider has not been met, the qualification module 134 may prevent the temporarily qualified service provider from receiving any further tasks from the task allocation application 142. If a notification is received from a module that a qualified service provider has violated the terms of the service agreement (e.g., a series of poorly performed tasks has occurred) or another problem has occurred, the qualification module 134 may disqualify the service provider and prevent the service provider from receiving tasks from the task allocation application 142. In one example, a disqualified service provider may complete prescribed training in order to be reinstated as a qualified service provider.

The banking module 136 may be configured to test a validity of a service provider's bank account. The service provider may provide bank account information, such as a banking institution name, a check routing number, and an account number. The banking module 136 may verify that the bank account information provided by the service provider is accurate. In one example, the banking module 136 may deposit a small amount of money (e.g., a micro deposit of two cents) into the service provider's bank account. The deposit may also include an identification number. The service provider may provide the deposit amount and the identification number to the banking module 136 to complete the bank verification process. In other words, the ability of the service provider to access information from the bank account may verify that the service provider is the owner of the bank account and has control of the funds in the bank account.

The installation verification module 138 may be configured to verify the installation of an application by the service provider on a mobile device to access the task allocation application 142. The application on the mobile device (i.e. a mobile application) may be used to view tasks assigned by the task allocation application 142. The mobile application may provide details about a plurality of tasks assigned to the service provider, such as the time of the task, the name of the customer, the address at which the task is to be performed, etc. The mobile application may notify the service provider of new tasks that are assigned and existing tasks that are modified in a timely manner. Furthermore, the mobile application may enable the service provider to receive task information even when performing a task at a location (e.g., a backyard or job site) without access to a computer connected to a wired or fixed network. When the mobile application is installed on the mobile device, the mobile application may send a confirmation message with service provider related information to the installation verification module 138. In other words, the installation verification module 138 may verify that the mobile application was installed by a specific service provider after receiving the confirmation message from the mobile application.

Certain processing modules may be discussed in connection with this technology and FIG. 1. In one example configuration, a module of FIG. 1 may be considered a service with one or more processes executing on a server or other computer hardware. Such services may be centrally hosted functionality or a service application that may receive requests and provide output to other services or consumer devices. For example, modules providing services may be considered on-demand computing that is hosted in a server, cloud, grid, or cluster computing system. An application program interface (API) may be provided for each module to enable a second module to send requests to and receive output from the first module. Such APIs may also allow third parties to interface with the module and make requests and receive output from the modules. Third parties may either access the modules using authentication credentials that provide on-going access to the module or the third party access may be based on a per transaction access where the third party pays for specific transactions that are provided and consumed.

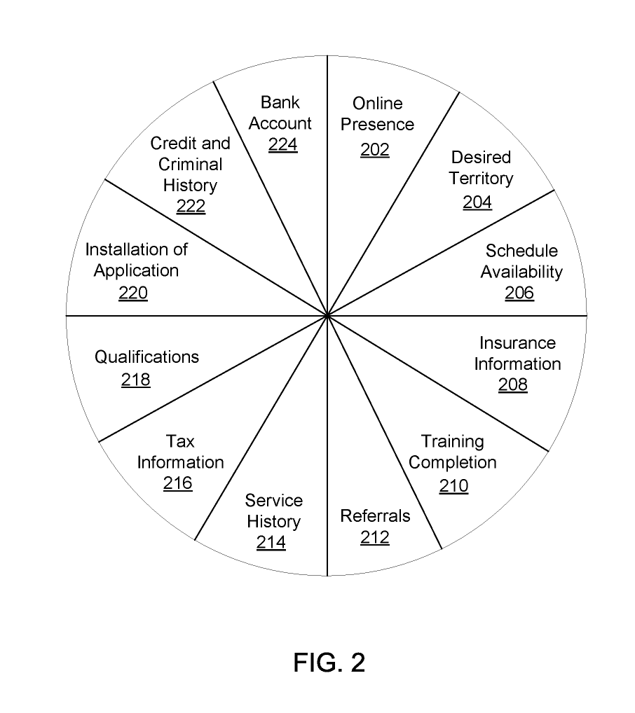

FIG. 2 illustrates a diagram showing examples of information used to qualify a service provider. The information used to qualify the service provider may include information in a number of areas that are provided by the service provider. The information may be reviewed and verified before the service provider is qualified to receive tasks from the task allocation application. In one example, each piece of information may be verified before the service provider is qualified to receive tasks from the task allocation application. Alternatively, the service provider may be temporarily or conditionally qualified to receive tasks from the task allocation application even though some of the information has not been received from the service provider or has not been verified to be accurate. For example, the service provider may be temporarily qualified when a piece of information is unable to be verified in real-time, or within a specific time window, such as during a weekend or holiday.

When the multiple parts or multiple pieces of the information have been provided or verified, the service provider may become a qualified service provider and continue to receive tasks from the task allocation application. If some of the pieces of information cannot be verified (or do not meet expectations) or if the service provider repeatedly fails to provide information, then the temporarily qualified service provider may stop receiving tasks from the task allocation application or may have tasks withdrawn. For example, a service provider who is conditionally certified may become uncertified if a background check fails. As another example, a conditionally certified service provider may become fully certified when a bank account becomes validated.

In one configuration, a qualified service provider may become unqualified or conditionally qualified based on actions that do not comply with a service provider agreement. The service provider agreement may define the responsibilities and quality of service that is expected of the service provider. For example, the service provider may receive quality of service ratings from customers for tasks that are performed. If the ratings drop below a certain threshold (e.g., a pattern of poor quality work or untimely appearances), then the service provider may be downgraded from a qualified service provider to a temporarily qualified or conditionally qualified service provider for a period of time (e.g., until the ratings of the service provider improves) or the service provider is disqualified from receiving tasks from the task allocation application. As another example, a series of missed or late service performances may result in a probationary period for the service provider. In one example instance, the service provider may become qualified again by completing a training program.

Returning to FIG. 2, the information used to qualify the service provider may include, but is not limited to, an online presence 202, a desired territory 204, schedule availability 206, insurance information 208, training completion 210, referrals 212, service history 214, tax information 216, qualifications 218, installation of an application 220 (e.g., a mobile application), credit and criminal history 222, and/or bank account information 224. The information may be used to qualify the service provider for receiving tasks from the task allocation application.

While the ability of the present technology to use service provider submitted information to validate a service provider to receive tasks has already been discussed, each of the areas where this information may be received will be discussed in additional detail.

The online presence 202 of the service provider may be used to qualify the service provider. The online presence 202 may relate to online credentials, such as websites, social networking sites, online databases, etc. that include information about the service provider. The online credentials may include biographical data about the service provider (e.g., name, address, contact information, education level), work experience, business information, financial information, etc. For example, the service provider may provide a business website showing that the service provider is an established service provider. In addition, the service provider may show registration of the business in the online database. In general, the online credentials may verify that the service provider is a real person and is established in performing the type of services that are claimed.

The desired territory 204 provided by the service provider may indicate the desired geographical locations where the service provider is able to perform services. The desired territory 204 indicated by the service provider may be verified to enable the assignment of tasks that the service provider can perform. The service provider may be requested to redefine the desired territory 204 if the desired territory 204 exceeds a predefined geographical area (e.g., five square miles). In addition, the service provider may be requested to redefine the desired territory 204 if the desired territory 204 is oversaturated with service providers that perform the same task as the service provider (e.g., lawn mowing). In one example, the service provided may be requested to shift the desired territory 204 if the geographical region specified by the service provider overlaps with the territories of other similar service providers. The requests to redefine the territory may also be machine generated and the service provider may have the opportunity to either accept or reject such automatically generated territory revisions.

The schedule availability 206 of the service provider may be used to qualify or certify the service provider. The service provider may provide the service provider's schedule availability 206 to enable the task allocation application to allocate tasks to the service provider. The task allocation application may assign tasks to the service provider during days and times when the service provider is free to perform tasks, as indicated by the schedule availability 206 information category.

Insurance information 208 may be provided by the service provider to show that the service provider has a valid and current insurance policy. Depending on the type of task performed by the service provider, an insurance policy may or may not be needed. The insurance policy may be verified by contacting the insurance provider of the insurance policy (e.g., via an electronic message). In one example, the insurance policy may be validated without contacting the insurance provider (e.g., by looking at a receipt from the service provider showing that the insurance was paid for). The insurance policy may be verified to determine that the policy meets a minimum dollar amount (e.g., $10,000) and that the policy is not expired. The insurance policy may be automatically verified in the future according to a predefined time period (e.g., every six months or upon expected policy expiration) to avoid insurance lapses.

The training completion 210 information area indicates that the service provider is desired to complete training to ensure that the service provider is familiar with the task allocation application and other software tools. In addition, the service provider may complete training for tasks that require a high degree of skill (e.g., electrical or plumbing tasks). The service provider may complete the training in order to be qualified to receive tasks from the task allocation application. Further, the service provider may complete additional training (e.g., one training session per month) in order to continue receiving tasks from the task allocation application. If the service provider fails to complete the assigned training sessions, the service provider may be placed in a probationary period until the training is completed. The probationary period may result in no new tasks being assigned from the task allocation application to the service provider.

The referrals information 212 may include the collection of information about former or current employers, colleagues, teachers, advisors, employees, friends, family members, etc. that can vouch for the service provider's reliability and skill level. For example, a former colleague may attest to the competency level of the service provider, and a former boss may verify that the service provider is a hard worker. The referrals 212 may be contacted (e.g., by telephone, email) to verify that the statements made by the service provider are complete and accurate.

The service history 214 information may be used to examine the experience of the service provider. The service history 214 may explain the types of tasks performed by the service provider for a given period of time. For example, the service history 214 may reflect that the service provider has performed plumbing work for the past ten years. Accordingly, the service history 214 may be used to determine that the service provider meets the defined experience level to perform specific tasks for customers. The service history 214 may be verified by contacting past customers to corroborate the statements made by the service provider. When qualifying the service provider, the specifications for the extent of the service provider's service history 214 may vary depending on the type of task the service provider seeks to perform. For instance, a service history 214 indicating that the service provider has two weeks of experience in mowing lawns may be adequate, but a service history 214 indicating that the service provider has one week of experience in repairing electrical wiring may be inadequate to qualify the service provider.

Tax information 216 may be requested from the service provider for withholding an appropriate amount of taxes from the service provider's pay. The tax information may be used to generate tax forms that indicate the amount of money earned by the service provider in a given year. In addition, the service provider may use the tax forms when filing tax returns. Without the service provider's tax information, taxes cannot be withheld and tax information cannot be sent to the service provider at the end of a given year.

The qualifications 218 may be information used to determine whether the service provider is qualified to perform certain task types for customers. In addition, the service provider may provide permits, certificates, licenses, etc. to show that the service provider is qualified to perform certain tasks. The documents provided by the service provider may be verified to prove that they are authentic and up-to-date. For example, a service provider (e.g., a plumber) may provide documents showing that the service provider graduated with a certificate from an accredited plumbing program, has passed the training requirements, and has been issued a license from a plumbing licensing entity. In one example, the documents (e.g., license, permit) may be verified by contacting the entity that issued the document.

The installation of an application 220 may indicate that the service provider has installed an application on a mobile device. The application may enable the service provider to quickly accept tasks assigned by the task allocation application. In addition, the service provider may view tasks that have been scheduled, modified or cancelled. By installing the application on the mobile device, the service provider can view a schedule of tasks, even when the service provider is away from a desktop computer. The service provider may download and install the application on the mobile device. During the installation, the service provider may authenticate the application with a centralized server. In addition, a notification may be sent from the mobile device when the application has been installed or deleted from the mobile device.

The credit and criminal history 222 of the service provider may be used to qualify the service provider. While some petty criminal offenses may not be a bar to qualifying service providers, serious criminal offenses may prevent a service provider from being qualified. The types of criminal offenses may be outlined in a service provider agreement. In one example, the service provider may not exceed a predetermined number of petty criminal offenses, as defined by the service provider agreement. In a credit history example, the service provider may be precluded from being qualified if the service provider's credit score is below a predetermined level. In this way, a credit score may be used as an indicator of reliability. The service provider's credit score may be negatively affected by late or missed payments, bankruptcy, liens, unemployment, etc.

Bank account information 224 may be requested from the service provider in order to deposit funds into the service provider's bank account. The funds may constitute payment for tasks performed by the service provider. The bank account information 224 may include a bank account number, a name of the banking institution, etc.

The bank account information 224 may also be verified to ensure that the service provider has access and control of the funds in the bank account. The bank account may be verified by checking the accuracy of the bank account information 224 or making micro deposits into the bank account and requesting the service provider to verify the micro deposits, as described earlier.

In one configuration, the service provider may be requested to provide additional information that may or may not be used to qualify the service provider. For example, the service provider may be requested to provide information on the tools used to perform services for customers. The service provider may be ask to confirm that the service provider has possession of the necessary tools needed to perform tasks for customers (e.g., a lawn mower for mowing lawns, a snow shovel for shoveling snow). Furthermore, additional information about the tools may be requested, such as tool make, tool model, tool serial number, date of purchase, or age of tools. The service provider may be asked whether the service provider purchased the tools, and if not, who purchased the tools. If the service provider did not purchase the tools, then this may indicate that the service provider is an employee, rather than a business owner. The tool information may be requested to ensure that the service provider possesses the necessary tools to perform the tasks assigned by the task allocation application and that the tools are in working condition.

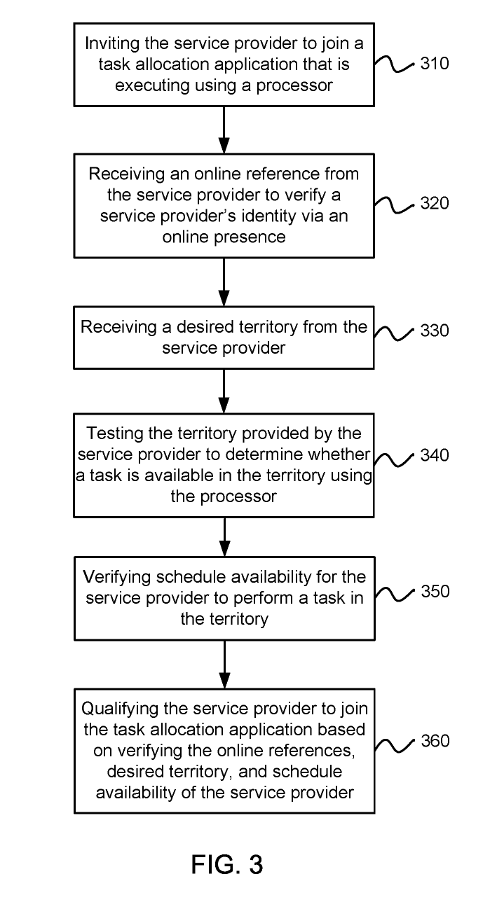

Referring now to FIG. 3, a method is illustrated for qualifying a service provider. The service provider may be invited to join a task allocation application that is executing using a processor, as in block 310. The service provider may be invited to join the task allocation application via an existing contractor, a customer, or direct marketing. For example, an invitation may be sent to the service provider after a qualified service provider or an existing customer recommends the service provider to join the task allocation application. In addition, the service provider may be sent an invitation after completing a pre-qualification process, either on a website or verbally (e.g., in person or by telephone).

An online reference from the service provider may be received to verify a service provider's identity via an online presence, as in block 320. The online reference may be verified using social media applications, social network relationships, electronic communication applications, media network links, online databases and other electronic reference tools. For example, the service provider may provide a business website to show that the service provider has an established and credible business for performing specific tasks (e.g., lawn mowing).

A desired territory may be received from the service provider, as in block 330. The desired territory may indicate the geographic regions where the service provider is willing and unwilling to perform tasks for customers.

The territory provided by the service provider may be tested to determine whether a task is available in the territory using the processor, as in block 340. For example, the service provider may indicate a desire to perform tasks within a certain city. Before a task is assigned, whether the task is within the territory provided by the service provider may be determined, and if so, the task may be assigned to the service provider. A modified territory may also be presented or suggested to the service provider where there is a conflict with other service provider's territories or no tasks available in the requested territory. The service provider may either accept or reject the proposed modified territory. However, rejecting the modified territory may mean that the service provider is not able to be qualified.

Schedule availability for the service provider to perform a task in the territory may be verified, as in block 350. The service provider may provide a list of days and times for which the service provider is available to perform tasks for customers. When a task is being assigned, the existence of an available time slot for the service provider to perform the task may be determined before the task is assigned to the service provider.

The service provider may be qualified to join the task allocation application based on verifying the online references, desired territory, and schedule availability of the service provider, as in block 360. A task for which the service provider is to perform may be allocated after the service provider has been qualified, based on the information provided by the service provider.

A validity of a bank account for the service provider may also be tested. For example, the bank account of the service provider may be tested for validity using test deposits. In addition, an installation of an application by the service provider on a mobile application may be verified in order to enable access to the task allocation application. The service provider may also be verified to have completed training regarding use of the task allocation application in order to qualify for task allocation. Furthermore, a service provider's referrals may be requested to qualify the service provider to use the task allocation application.

In one configuration, a service provider's service history may be requested to validate the service provider. Business license information, certification information, certificates, permits, licenses or qualification from the service provider may also be verified to validate the service provider. Furthermore, whether the service provider owns a pre-defined tool (e.g., a lawn mower) may be checked. Detailed tool information from the service provider may be requested, such as tool make, tool model, date of tool purchase, age of tools, tool serial number, etc.

A task definition having task details for the task to be performed for a customer may be obtained by the service provider. A task price for the task may be set based on the task details and statistical price data. Payment may be received from the customer when the task is ordered or prior to when the task is assigned to the service provider. The task may be assigned to the service provider after qualification of the service provider is complete.

In one configuration of the technology, taxes for the service provider may be withheld based on the task price paid for the task. An independent contractor tax form may be sent to the service provider for performing tasks. In addition, insurance information about an insurance policy related to the task may be obtained from the service provider. The insurance policy may be verified to be valid and current using the insurance information. Furthermore, a criminal or credit history for the service provider may be checked to determine whether the service provider is qualified.

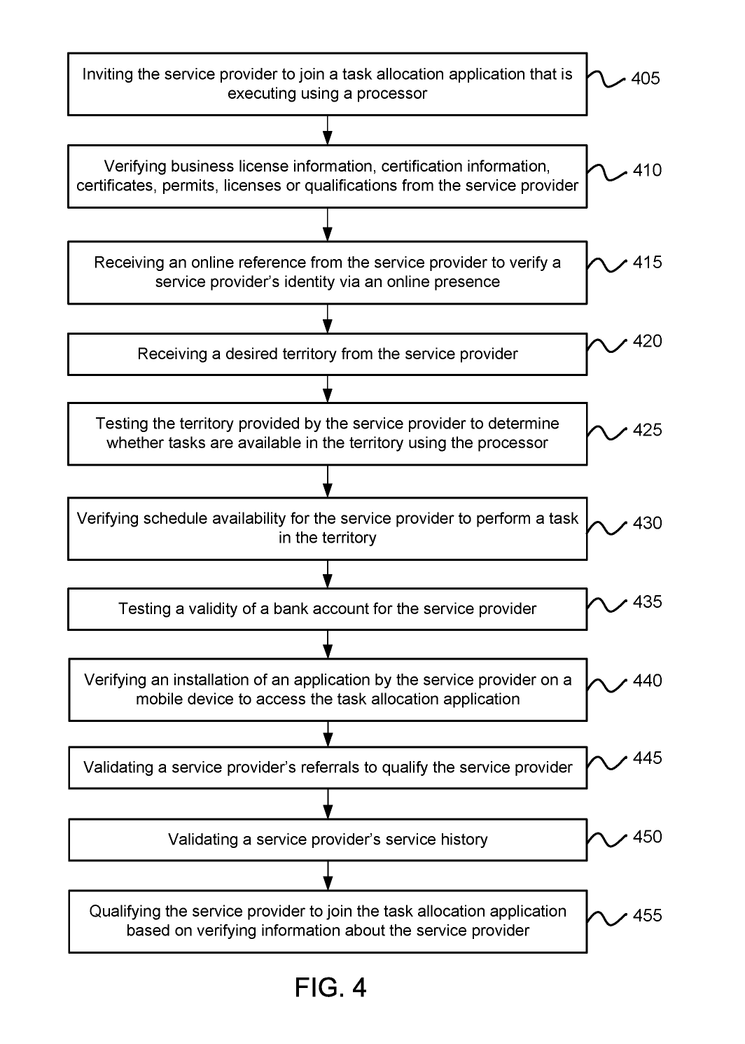

Referring now to FIG. 4, a more detailed method is illustrated for qualifying a service provider to receive a task. The service provider may be invited to join a task allocation application that is executing using a processor, as in block 405. The service provider may be invited to join via a qualified contractor, an existing customer, or direct marketing. For example, the service provider may receive an email with the invitation through direct marketing. The email with the invitation may be automatically sent to service providers that are included in an online database (e.g., a phone directory, yellow pages). In addition, the service provider may receive an invitation in the mail with instructions for signing up to be a qualified service provider.

Business license information, certification information, certificates, permits, licenses or qualifications from the service provider may be verified, as in block 410. For example, the service provider may provide documents (e.g., licenses, permits) showing that the service provider is authorized to perform a task. The authenticity of the documents may be verified with the entity that issued the license, permit, etc.

An online reference from the service provider may be received to verify a service provider's identity via an online presence, as in block 415. For example, the service provider may provide business websites, advertisements, etc. showing that the services the service provider claims to offer are actually offered to customers

A desired territory may be received from the service provider, as in block 420. The service provider may provide geographic areas (e.g., cities, regions, neighborhoods) where the service provider is able or unable to perform services. The task allocation application may not assign tasks in locations where the service provider is unable to perform tasks.

The territory provided by the service provider may be tested to determine whether tasks are available in the territory using the processor, as in block 425. For example, the service provider may express a desire to perform snow shoveling in a specific area (e.g., a northwest section of a city). Then it may be determined whether snow shoveling is available in this specific area, and if not, the service provider may be prompted to provide alternative areas where snow shoveling services can be offered. In addition, the service provider may be asked to provide additional services that can be performed (e.g., lawn mowing) in the specific area provided by the service provider.

Schedule availability for the service provider to perform a task in the territory may be verified, as in block 430. The service provider may provide dates and times when available to perform tasks for customers. The task allocation application may verify that the service provider has schedule availability before assigning a task at a specific time. If the service provider is not available to perform the task, the task allocation application may assign the task to another service provider with schedule availability to perform the task.

A validity of a bank account for the service provider may be tested, as in block 435. The service provider may provide bank account information, such as bank account number, routing number, etc. The bank account may be verified to ensure that the service provider owns and has control of the funds in the bank account. In addition, verifying the bank account may ensure that funds are correctly being deposited and withdrawn to and from the service provider's bank account.

An installation of an application by the service provider on a mobile device to access the task allocation application may be verified, as in block 440. By installing the task allocation application on the mobile device, the service provider may timely receive task information (e.g., newly assigned tasks, cancelled tasks), even when the service provider is performing a task on location. In addition, the service provider may be verified to have completed training regarding use of the task allocation application in order to qualify for task allocation.

A service provider's referrals may be verified to qualify the service provider, as in block 445. For example, the service provider may provide former or current supervisors, colleagues, teachers, etc. as referrals to vouch for the competence and reliability of the service provider. The referrals may be contacted (e.g., electronically) to verify that the assertions made by the service provider are accurate.

A service provider's service history may be validated, as in block 450. For example, the service provider may provide a list of previously performed tasks. The list may include information for each task, such as: the date the task was performed, the type of task, and the name of the customer. The service history may be verified by, for example, contacting random customers from the list and verifying the statements provided by the service provider.

In addition, the ownership of specific tools to perform the task may be checked. For example, if the service provider claims to be capable of mowing lawns, it may be verified that the service provider owns a lawn mower. In addition, the service provider's tools may be verified to be up-to-date and in working order. In a further example, a service history or repair history of the tool may be requested to ensure that the tool has been properly maintained.

The service provider may be qualified to join the task allocation application based on verifying information about the service provider, as in block 455. For example, license information, online reference information, bank account information, referral information, etc. may be used to qualify the service provider. The service provider may be fully qualified, temporarily qualified, or not qualified. The service provider may be fully qualified when the requested information has been provided and verified. The service provider may be temporarily qualified when some portions of the information have been provided and verified, but other portions of the information have not yet been provided and verified. The service provider may be not qualified when portions of the information do not exist or do not meet the necessary criteria for qualifying the service provider.

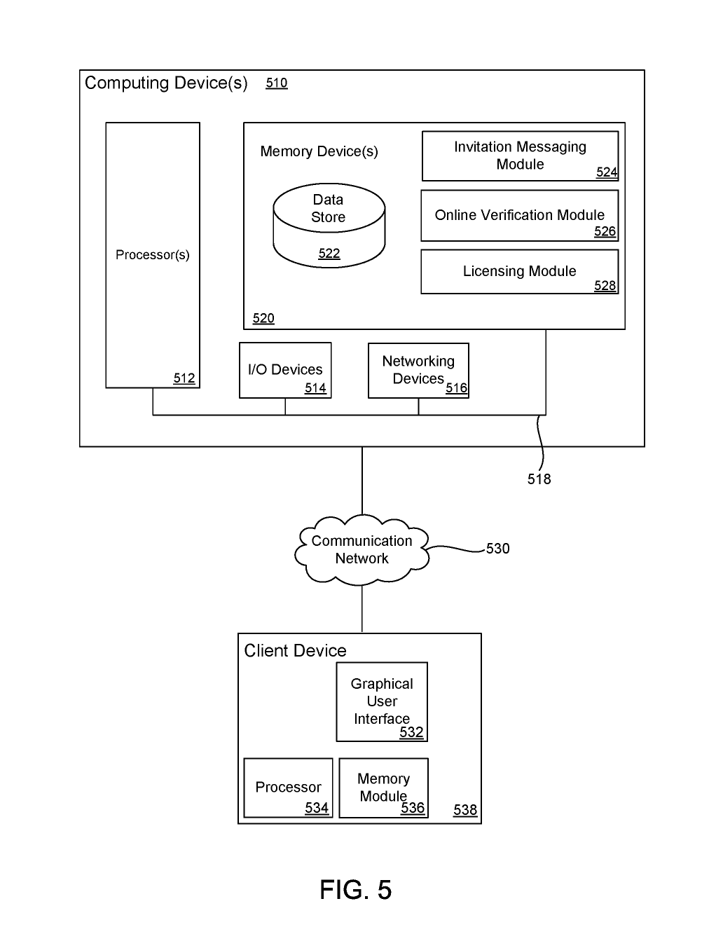

FIG. 5 illustrates a computing device 510 on which modules of this technology may execute. A computing device 510 is illustrated on which a high level example of the technology may be executed. The computing device 510 may include one or more processors 512 that are in communication with memory devices 520. The computing device may include a local communication interface 518 for the components in the computing device. For example, the local communication interface may be a local data bus and/or any related address or control busses as may be desired.

The memory device 520 may contain modules that are executable by the processor(s) 512 and data for the modules. Located in the memory device 520 are modules executable by the processor. For example, an invitation messaging module 524, an online verification module 526, a licensing module 528 and other modules may be located in the memory device 520. The modules may execute the functions described earlier. A data store 522 may also be located in the memory device 520 for storing data related to the modules and other applications along with an operating system that is executable by the processor(s) 512.

Other applications may also be stored in the memory device 520 and may be executable by the processor(s) 512. Components or modules discussed in this description that may be implemented in the form of software using high programming level languages that are compiled, interpreted or executed using a hybrid of the methods.

The computing device may also have access to I/O (input/output) devices 514 that are usable by the computing devices. An example of an I/O device is a display screen 530 that is available to display output from the computing devices. Other known I/O device may be used with the computing device as desired. Networking devices 516 and similar communication devices may be included in the computing device. The networking devices 516 may be wired or wireless networking devices that connect to the internet, a LAN, WAN, or other computing network.

The components or modules that are shown as being stored in the memory device 520 may be executed by the processor 512. The term “executable” may mean a program file that is in a form that may be executed by a processor 512. For example, a program in a higher level language may be compiled into machine code in a format that may be loaded into a random access portion of the memory device 520 and executed by the processor 512, or source code may be loaded by another executable program and interpreted to generate instructions in a random access portion of the memory to be executed by a processor. The executable program may be stored in any portion or component of the memory device 520. For example, the memory device 520 may be random access memory (RAM), read only memory (ROM), flash memory, a solid state drive, memory card, a hard drive, optical disk, floppy disk, magnetic tape, or any other memory components.

The processor 512 may represent multiple processors and the memory 520 may represent multiple memory units that operate in parallel to the processing circuits. This may provide parallel processing channels for the processes and data in the system. The local interface 518 may be used as a network to facilitate communication between any of the multiple processors and multiple memories. The local interface 518 may use additional systems designed for coordinating communication such as load balancing, bulk data transfer and similar systems.

The communication network 530 may represent any number of networks including those that may be a local area network (LAN), wide area network (WAN), or the internet. The client device 538 may represent multiple devices, for example, a desktop computer, a laptop, a tablet, a mobile device, a television, a cell phone, a smart phone, a hand held messaging device, a set-top box, a gaming console, a personal data assistant, an electronic book reader, heads up display (HUD) glasses, or any device with a display that may present the graphical user interface 532. The graphical user interface 532 of the client device 538 may enable a user to type, speak, write, or select task parameters that the client device 538 may capture. The client device 538 may include a processor 534 and a memory module 536.

Some of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more blocks of computer instructions, which may be organized as an object, procedure, or function. Nevertheless, the executables of an identified module need not be physically located together, but may comprise disparate instructions stored in different locations which comprise the module and achieve the stated purpose for the module when joined logically together.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices. The modules may be passive or active, including agents operable to perform desired functions.

The technology described here can also be stored on a computer readable storage medium that includes volatile and non-volatile, removable and non-removable media implemented with any technology for the storage of information such as computer readable instructions, data structures, program modules, or other data. Computer readable storage media include, but is not limited to, RAM, ROM, EEPROM, flash memory or other memory technology, CD-ROM, digital versatile disks (DVD) or other optical storage, magnetic cassettes, magnetic tapes, magnetic disk storage or other magnetic storage devices, or any other computer storage medium which can be used to store the desired information and described technology.

The devices described herein may also contain communication connections or networking apparatus and networking connections that allow the devices to communicate with other devices. Communication connections are an example of communication media. Communication media typically embodies computer readable instructions, data structures, program modules and other data in a modulated data signal such as a carrier wave or other transport mechanism and includes any information delivery media. A “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio frequency, infrared, and other wireless media. The term computer readable media as used herein includes communication media.

Furthermore, the described features, structures, or characteristics may be combined in any suitable manner in one or more examples. In the preceding description, numerous specific details were provided, such as examples of various configurations to provide a thorough understanding of examples of the described technology. One skilled in the relevant art will recognize, however, that the technology can be practiced without one or more of the specific details, or with other methods, components, devices, etc. In other instances, well-known structures or operations are not shown or described in detail to avoid obscuring aspects of the technology.

Although the subject matter has been described in language specific to structural features and/or operations, it is to be understood that the subject matter defined in the appended claims is not necessarily limited to the specific features and operations described above. Rather, the specific features and acts described above are disclosed as example forms of implementing the claims. Numerous modifications and alternative arrangements can be devised without departing from the spirit and scope of the described technology.

1. A method for qualifying a service provider, comprising:
inviting the service provider to join a task allocation application that is executing using a processor;
receiving an online reference from the service provider to verify a service provider's identity via an online presence;
receiving a desired territory from the service provider;
testing the territory provided by the service provider to determine whether a task is available in the territory using the processor;
verifying schedule availability for the service provider to perform the task in the territory; and
qualifying the service provider to join the task allocation application based on verifying the online references, desired territory, and schedule availability of the service provider.

2. The method as in claim 1, further comprising allocating the task for the service provider to perform after the service provider has been qualified.

3. The method as in claim 1, further comprising inviting the service provider to join the task allocation application via an existing contractor, a customer, or direct marketing.

4. The method as in claim 1, further comprising verifying the online reference using social media applications, social network relationships, electronic communication applications, media network links and online databases.

5. The method as in claim 1, further comprising testing a validity of a bank account for the service provider.

6. The method as in claim 5, further comprising testing the bank account of the service provider for validity using test deposits.

7. The method as in claim 1, further comprising verifying an installation of an application by the service provider on a mobile device in order to enable access to the task allocation application.

8. The method as in claim 1, further comprising verifying the service provider has completed training regarding use of the task allocation application in order to qualify for task allocation.

9. The method as in claim 1, further comprising requesting a service provider's referrals to qualify the service provider to use the task allocation application.

10. The method as in claim 1, further comprising requesting a service provider's service history to validate the service provider.

11. The method as in claim 1, further comprising verifying business license information, certification information, certificates, permits, licenses or qualifications from the service provider to validate the service provider.

12. The method as in claim 1, further comprising checking whether the service provider owns a pre-defined tool.

13. The method as in claim 12, further comprising requesting detailed tool information from the service provider including tool make, tool model, date of purchase, age of tools and tool serial number.

14. The method as in claim 1, further comprising:
obtaining a task definition having task details for the task to be performed for a customer by the service provider;
setting a task price for the task based on the task details and statistical price data using the processor;
receiving payment from the customer when the task is ordered or prior to when the task is assigned to the service provider; and
assigning the task to the service provider after qualification of the service provider is complete.

15. The method as in claim 14, further comprising withholding taxes for the service provider based on the task price paid for the task.

16. The method as in claim 14, further comprising sending an independent contractor tax form to the service provider for performing the task.

17. The method as in claim 1, further comprising:
obtaining insurance information about an insurance policy related to the task from the service provider; and
verifying the insurance policy is valid and current using the insurance information.

18. The method as in claim 1, further comprising checking a criminal or credit history for the service provider to determine whether the service provider is qualified.

19. A method for qualifying a service provider to receive a task, comprising:
inviting the service provider to join a task allocation application that is executing using a processor;
verifying business license information, certification information, certificates, permits, licenses or qualifications from the service provider;
receiving an online reference from the service provider to verify a service provider's identity via an online presence;
receiving a desired territory from the service provider;
testing the territory provided by the service provider to determine whether tasks are available in the territory using the processor;
verifying schedule availability for the service provider to perform the task in the territory;
testing a validity of a bank account for the service provider;
verifying an installation of an application by the service provider on a mobile device to access the task allocation application;
validating a service provider's referrals to qualify the service provider;
validating a service provider's service history; and
qualifying the service provider to join the task allocation application based on verifying information about the service provider.

20. The method as in claim 19, further comprising inviting the service provider to join via an existing contractor, a customer, or direct marketing.

21. The method as in claim 19, further comprising verifying the service provider has completed training regarding use of the task allocation application in order to qualify for task allocation.

22. The method as in claim 19, further comprising checking whether the service provider owns a specific tool to perform the task.

23. A system to qualify a service provider to receive a task from a task allocation application executing using a processor and memory, comprising:
an invitation messaging module to invite the service provider to join the task allocation application;
an online verification module to verify a service provider's online presence;
a licensing module to verify the service provider's licensing, permits, certifications or qualifications; and
a territory module to determine whether the task is available in a territory desired by the service provider;
a scheduling module to verify schedule availability for the service provider to perform the task in the territory;
a history module to verify a service providers references or service history; and
a qualification module to qualify the service provider when qualification criteria are met.

24. The system as in claim 23, further comprising a banking module to test a validity of a bank account for the service provider.

25. The system as in claim 23, further comprising an installation verification module to verify the installation of an application by the service provider on a mobile device to access the task allocation application.
